(19) United States
(12) Patent Application Publication
(10) Pub. No.: US 2005/0080932 A1
(43) Pub. Date: Apr. 14, 2005

(54) New generation fax machine

(76) Inventor: Pao-Kang Liu, Santa Clara, CA (US)

Correspondence Address: Donald W. Meeker;Patent Agent, #E, 924 East Ocean Front, Newport Beach, CA, 92661, US

(21) Appl. No.: 10/683,365

(22) Filed: Oct. 9, 2003

(51) Int. Cl. G06F 15/16

(52) U.S. Cl. 709/249

(57) ABSTRACT

A facsimile machine with multi-port networking capabilities and a compact flash card for data storage, which does not have printing components, but uses a computer and printer for printing.

### BACKGROUND OF THE INVENTION

1. Field of the Invention

The present invention relates to facsimile machines, and in particular one that has multi-port networking capabilities, uses a compact flash card for data storage, and does not have printing components, but uses a computer and printer when desired to print.

2. Description of the Prior Art

A fax machine is a popular home/office appliance used for telecommunication purposes. In addition to a regular telephone's answering and calling function, a traditional fax machine is also able to transmit, receive, and/or copy documents. Nowadays some advanced fax machines can also be used as printers when they have computers hooked on.

When the current machine receives a fax, the signal from phone jack will go through telephone system, demodulated by fax modem, and control unit will store the imagines and print out a hard copy by the printing unit.

Home networking is a fast emerging trend spurred by the availability of broadband access and networked devices for use in the home or office. Small office/home office (SOHO) and residential computers may permanently connect to external networks such as the Internet via these broadband connections. The computers within a SOHO or a residential environment can be connected together by private or home networks to share resources including the broadband connection. A private/home network can be connected to the broadband connection via a gateway device such as a personal computer running gateway software or a special purpose gateway device. A common configuration that is seen in private/home networks involves an Internet Gateway device (IGD) running Network Address Translation (NAT) software.

Prior art devices have made some modifications but lack full integration of systems for a truly effective paperless fax system.

Prior art U.S. Patent Application #20020051259, published May 2, 2002 by Yasunobu, depicts a facsimile apparatus that has a memory card input and output unit, data conversion management means for judging the type of image data receivable at the destination side, first converting means for converting from the YCbCr format used in the memory card into the RGB format, second converting means for converting from the RGB format into the L*a*b* format used in the color facsimile apparatus and monochromatic format converting means. If the data to be transmitted is the color image data of the memory card, the data is once converted into RGB format in the first converting means, and then converted into L*a*b* format in the second converting means, and in the case of the image data being read by the scanner, the data is directly converted into L*a*b* format in the second converting means. If the type of image data receivable at the destination side judged by the data conversion management means is color image, the data of L*a*b* format obtained in the second converting means is transmitted directly. If the type of image data receivable at the destination side is monochromatic image only, the data of L*a*b* format obtained in the second converting means is transmitted by converting into monochromatic format, and therefore if the destination side is a monochromatic facsimile apparatus, the color image can be automatically transmitted as monochromatic image. The memory card can be a SD (secure digital) memory card that is capable of protecting the copyright, a memory card conforming to the personal computer card standard, a Compact Flash card or Smart Media may be preferred, but the SD memory card is most preferred because the copyright can be protected.

Prior art U.S. Pat. No. 5,828,465, issued Oct. 27, 1998 to Muramatsu, shows a facsimile apparatus with an overwrite mode of operation and an append mode of operation. The image data for a document that is to be registered for polling transmission is stored in a memory in a manner which permits the image data to be easily modified, and additional data appended thereto. In the overwrite mode, previously stored data is automatically erased, and new image data is stored in the memory in its place. If the amount of new image data is greater than the amount of data that was previously stored, the additional data is stored in a manner, which links it to the area where the previously stored data was located. In the append mode, the new image data is similarly stored in a manner which links it to previously stored data. There is no need to erase or modify the originally stored data in this mode.

Prior art U.S. Pat. No. 6,147,774, issued Nov. 14, 2000 to Hamadani, claims a multifunction interface card for interfacing a facsimile machine, secure modem, and a personal computer. The facsimile communication system includes first and second facsimile machines, first and second modems, and a computer. The first facsimile machine includes a multifunction interface that is coupled to the first modem and the computer. The multifunction interface controls transfer of facsimile data from either the facsimile machine or the computer to the first modem with or without processing of the data. For example, the computer may provide data to the multifunction interface in conventional facsimile format using conventional facsimile software and the multifunction interface performs protocol conversion for transmission via the first modem. Alternatively, the computer may include specialized software that provides the conversion into the desired format for transmission via the first modem. In such a case, the multifunction interface passes through the data received from the computer. Likewise, a conventional facsimile machine may provide the data via the multifunction interface, which performs any desired protocol conversion. In a receive mode, a second facsimile machine sends data to the first modem which is converted if required by the multifunction interface and the converted data is provided to either the first facsimile machine or the computer.

Prior art U.S. Pat. No. 5,438,436, issued Aug. 1, 1995 to Harris, describes a fax machine that has improved functions, in which information is sent in a batch mode. A preferred embodiment of this invention separates the printer and processor so that a single printer can serve multiple fax machines. The fax is sent in a random orientation and this orientation is rotated prior to sending. Security aspects are also handled by storing all pages in memory, taking a picture of an area when faxing and taking a picture of an area based on an alarm mode. A color embodiment is also described which send faxes in color, including handshaking modes for determining whether color should be sent. Another embodiment of the invention straightens the lines of faxes prior to sending. Multiple modes of transmission are described. Finally, a power down mode is described, which is specially optimized for fax machines and their problems.

Prior art U.S. Pat. No. 5,719,688, issued Feb. 17, 1998 to Kagami, discloses a communicating apparatus that has a plurality of ports to connect a plurality of communication lines. The apparatus comprises a memory to store information indicating whether the plurality of communication lines are extensions of a private branch network or not, a designating circuit to designate whether the communication is to be executed through said extensions or not, and a selector to select one of the plurality of ports in accordance with the result of the designation of the designating circuit and the contents of the memory. The memory stores information indicating whether the communication lines are ISDN lines or PSTN lines. The selector includes a call generating circuit for generating a call in the G4 facsimile mode when the selected communication line is an ISDN line and for generating a call in the G3 facsimile mode when it is decided that the partner is not a G4 facsimile apparatus after completion of the call generation.

Prior art U.S. Pat. No. 5,278,664, issued Jan. 11, 1994 to Jang, indicates a method for increasing communication efficiency in a multi-port facsimile. The method for transmitting message of a document in a multi-port facsimile, in which the messages to be transmitted are registered in a memory unit in file unit together with a specific message-registration table. All the registered messages that have the same destination are re-registered in a specific transmission-result table for subsequent transmission to the destination in one dial-up.

Prior art U.S. Pat. No. 6,486,970, issued Nov. 26, 2002 to Oak, puts forth a multifunctional apparatus that transfers and receives facsimile data and communication data by using an integrated service digital network constructed with a computer interface conducting facsimile and communication data. The apparatus also has a line interface transferring data to the network and receiving facsimile and communication data from the network at the first transfer rate. The apparatus further includes an ISAC controlling a connection with the integrated service digital network, conducting facsimile and communication data via the network, converting the transfer rate of data received from the network to a second transfer rate, and converting the transfer rate of data received from for the network to the first transfer rate. A serial I/O converts the communication data transmitted from the computer through the computer interfacing section, and facsimile data scanned in a scanning section, into serial data, and transfers serial data to the ISAC, and receives communication and facsimile data from the network via the ISAC.

Prior art U.S. Pat. No. 6,348,970, issued Feb. 19, 2002 to Marx, concerns an apparatus and method for interfacing a facsimile machine with a computer network. The apparatus provides a fax interface for exchanging faxes with fax machine and a network interface for communicating with and retrieving electronic documents from a computer network. The apparatus further includes a memory for storing the electronic documents received from the computer network and the faxed pages received from the fax machine and a controller for comparing the electronic documents to the faxed pages. The apparatus may be employed to retrieve various electronic documents from the computer network in response to received faxes.

Prior art U.S. Pat. No. 5,291,302, issued Mar. 1, 1994 to Gordon, illustrates a facsimile telecommunications system and method that has one or more store and forward facilities, (SAFF) each associated with a plurality of subscriber facsimile machines. The SAFF include a computer for controlling operations and mass data storage equipment. A subscriber to the system delivers an outgoing facsimile message to the SAFF with which it is associated, which records the fax message, together with data as to originating facsimile machine and destination facsimile machine. The SAFF then delivers the facsimile message to the intended receiver facsimile machine, either directly or through another SAFF. If unsuccessful on an initial attempt, the SAFF periodically retries to send the facsimile message. The system also provides spooling of all facsimile messages for an intended receiver machine, which are all spooled upon connection with the receiver machine. Subscriber mailboxes are provided as part of the mass storage, which can be accessed by a subscriber to have his messages delivered to any facsimile machine he designates. Secure facsimile transmission is achieved through use of subscriber PIN numbers. Broadcasting redirecting messages and cost accounting can also be achieved by the system and method. After receipt of a message by the subscriber, the system may provide an immediate-reply service, allowing the recipient to immediately send out a message selected from a reply service menu. The system can also be used in cooperation with a paperless facsimile machine, which directly displays the facsimile message on a screen and is capable of entering outgoing facsimile messages to the SAFF. The system can convert the received fax message into voice mail message and direct the converted voice message to a voice mailbox as instructed by the message sender or recipient.

Prior art U.S. Pat. No. 6,452,691, issued Sep. 17, 2002 to Marshall, is for a method for transmitting facsimile documents from a facsimile store-and-forward service computer to a networked computer system. The networked computer system includes a central server computer and one or more computers coupled to the central server computer. According to a first embodiment of the present invention, the central server computer is programmed to determine whether the facsimile store-and-forward service computer has received a facsimile document for a particular user of the networked computer system. If so, the central server causes the facsimile store-and-forward service computer to transmit the facsimile documents to the central server computer. Upon receipt, the central server computer opens a file that is associated with the particular user and stores the facsimile document in the file. According to a second embodiment of the present invention, the facsimile store-and-forward service computer is programmed to transmit any received facsimile documents to the central server computer upon receipt. The service computer inserts a code into a header block that is transmitted with the facsimile document to indicate to the central server computer who is the intended recipient of the facsimile document. After receiving the header block, the central server computer reads the code and identifies the intended recipient, opens a file associated with the intended recipient, stores the received facsimile document in the file and notifies the intended recipient that a facsimile document has been received.

Prior art U.S. Pat. No. 5,844,970, issued Dec. 1, 1998 to Hsu, provides a multi-user personal message transmitting and receiving system that utilizes a conventional facsimile machine, a conventional facsimile machine that has line connections to the input/output port of a computer, a conventional paperless facsimile machine with memory for document storage, a MODEM equipped computer, or a conventional answering machine with mass memory for message storage. A dual tone multi-frequency decoder (DTMF receiver) is connected to the telephone network of the machine or computer utilized and a voice synthesizer is connected to the telephone network advising the caller on the telephone line concerning the personal information codes of the users of the system or advising the caller to enter the personal information code of the particular user prior to transmitting the message. A coding system is built into the central processing unit of the machine or computer utilized for setting and storing the individual user personal information codes and corresponding personal confidential codes and recognizing the incoming code preceding an incoming message. When the incoming code is recognized as one of the stored personal information codes, the coding system controls the automatic reception and storage of the incoming message in the respective code area of the memory which can be retrieved by the respective user by entering the respective personal confidential code.

Prior art U.S. Pat. No. 5,761,282, issued Jun. 2, 1998 to Hsu, shows a multi-user personal message transmitting and receiving system, which utilizes a conventional facsimile machine, a conventional facsimile machine that has line connections to the input/output port of a computer, a conventional paperless facsimile machine with memory for document storage, a MODEM equipped computer, or a conventional answering machine with mass memory for message storage. A dual tone multi-frequency decoder (DTMF receiver) is connected to the telephone network of the machine or computer utilized and a voice synthesizer is connected to the telephone network advising the caller on the telephone line concerning the personal information codes of the users of the system or advising the caller to enter the personal information code of the particular user prior to transmitting the message. A coding system is built into the central processing unit of the machine or computer utilized for setting and storing the individual user personal information codes and corresponding personal confidential codes and recognizing the incoming code preceding an incoming message. When the incoming code is recognized as one of the stored personal information codes, the coding system controls the automatic reception and storage of the incoming message in the respective code area of the memory which can be retrieved by the respective user by entering the respective personal confidential code.

Prior art U.S. Pat. No. 5,943,140, issued Aug. 24, 1999 to Monroe, claims a method and apparatus for sending and receiving facsimile transmissions over a non-telephonic transmission system. An interface is provided for connecting a standard telephone line and/or a standard facsimile machine with a distributive communication network interface such as a personal computer, whereby facsimile signal present on the telephone line or at the facsimile machine may be transmitted via the Internet to a remote station without the use of long distance or international telephone signal carriers. The facsimile signal may be sent or received via the network using the network, without interfering with the capability to receive and send facsimile signals in the normal manner via a standard telephone line.

Prior art U.S. Pat. No. 5,461,488, issued Oct. 24, 1995 to Witek, describes a computerized facsimile (FAX) system and method of operation. The fax system is automated herein by using a modem, a computer, and an office network, which coupled the computer to a plurality of end-user computers. Faxes are received by the computer through the modem. Once the fax is received a program stores the fax in a computer file in a non-text format. A code converts the non-text format of file to a text format, which is read by a pattern recognition program. The program determines, from the file, a destination of the fax document. The destination can be one or more of a printer, a computer in the plurality of computers, a default computer, or a default storage location (e.g., disk storage). A log file is kept by computer to record the operations of the computer and receipt routing information regarding received faxes. The control code coordinates the other programs in memory.

What is needed is a fully integrated system to form a combined fax, scanner, modem, and small office/home office (SOHO) switch.

### SUMMARY OF THE INVENTION

An object of the present invention is that it provides a fully integrated system to form a combined fax, scanner, modem, and small office/home office (SOHO) switch for a paperless fax with greatly expanded communication capability as a tele-networking tool.

A related object of the present invention is to add a removable compact flash card and USB port to the present improved system so the printing unit of a traditional fax system is deleted and the fax does not need to be printed out thereby saving trees as well as enabling the user to view the fax on the computer monitor.

Another object of the present invention is to provide a facsimile machine with the paper printing components removed from the fax machine, which is more compact.

One more object of the present invention is to provide a facsimile machine that has a lower manufacturing cost, due to its compact size.

An additional object of the present invention is to provide a facsimile machine that several users which connect to the network can view the received fax document at the same time.

A further object of the present invention is to provide a facsimile machine that besides documents may receive and store texts, pictures, or graphical files into a memory card, which are available for users to read.

In brief, a facsimile machine without a printer, which may be improved by integrating either a compact flash card or a multi-port SOHO switch (3 or 5 ports, for instance), and/or with a DSL or fax modem function supported. The compact flash card may be used as a data storage device for the fax machine. A compact flash card is a non-volatile storage device. It is small, portable, upgradeable, and convenient and comparatively has huge storage capacity. The fax machine may be turned from telephony into a tele-networking tool by adding a multi-port SOHO switch (3 or 5 ports, for instance), and/or with a DSL or fax modem function supported. There are two proposed systems after adding the new components, a USB Paperless Fax System and a USB Paperless Switch Fax System.

In the USB Paperless Fax System the printing unit in a traditional fax system is deleted by adding a removable compact flash card and a USB port. The USB Paperless Fax System works by:

Receiving faxes: Upon receiving, the data will go through fax modem and control unit, then store into the compact flash card. When users want to view or delete the fax, he or she can use a compact flash card reader or hook up a USB cable to connect to a computer's USB port. The imagines or pictures may then be viewed from the computer screen. These pictures can be printed out later from the printers connected to the computer.

Transmitting faxes: The fax machine can fax the documents from a scan device like traditional fax machine.

Telephone calling/answering: Works as a traditional telephone system.

Scanning: The fax machine can be used as a black/color scanner and can store the scanned pictures in the compact memory. Users can view and download it to their computers from the USB port.

USB Paperless Switch Fax System is created by adding a multi-port (3 or 5 ports, for instance) switch SOC (system-on-a-chip with embedded CPU) and a data flow arbiter. The SOC has an Ethernet interface to communicate with networking devices attached to it. It also has a CPU core to read/write data in the compact flash card and schedule fax tasks with the control unit. The arbiter is used to control the data flow between SOC, USB or other communication ports, such as an IEEE 1394. The USB Paperless Switch Fax System works by:

Receiving faxes: Upon receiving, the data will be stored into the compact flash card. Users can view or delete the fax from all the devices hooked with the Ethernet switch. The fax can also be read similar to the USB paperless fax system by using a compact flash card reader or from its USB port. The document can be printed out from the printers connected to the computers or network.

Transmitting faxes: The fax machine can fax documents that generate from a scanning device, or transmit scheduled fax events by networking device.

Telephone calling/answering: Works as traditional telephone.

Scanning: The fax machine can be used as a black/color scanner. The scanned pictures may be stored in the compact memory. The user can then view and download the file from the computer at any time.

Network switching: Many computers can connect to its switch ports to access the files at the same time.

An advantage of the present invention is that it combines the functions of a traditional fax machine, scanner, modem, and SOHO switch.

Another advantage of the present invention is that it conserves paper.

A further advantage of the present invention is that it has data storing capabilities.

An additional advantage of the present invention is that it is inexpensive to manufacture.

One more advantage of the present invention is that it is compact.

Another advantage of the present invention is that a user may view the fax from their computer screen.

Yet another advantage of the present invention is that several network users may view a fax at once.

Still another advantage of the present invention is that it works as traditional telephone.

### BRIEF DESCRIPTION OF THE DRAWINGS

These and other details of my invention will be described in connection with the accompanying drawings, which are furnished only by way of illustration and not in limitation of the invention, and in which drawings:

FIG. 1 is a diagrammatic view showing the components of prior art fax machines and the interactive flow of communication between the components and communication devices;

FIG. 2 is a diagrammatic view showing the components of the invention and the flow of communication between them and other communication devices, wherein a removable compact flash card and USB port are added to a smaller fax unit and the printing unit of a traditional fax system is deleted;

FIG. 3 is a diagrammatic view showing the components of the invention and the flow of communication between them and other communication devices, wherein a multi-port (3 or 5 ports, for instance) switch SOC (system-on-a-chip with embedded CPU) and a data flow arbiter are added to a smaller fax unit, in a USB/IEEE 1394 paperless switch fax system wherein the SOC has its Ethernet interface to communicate with networking devices attached to it and also has a CPU core to read/write data in the compact flash card and schedule fax tasks with the control unit and the arbiter is used to control the data flow between the SOC, USB or other communication ports (such as IEEE 1394).

### BEST MODE FOR CARRYING OUT THE INVENTION

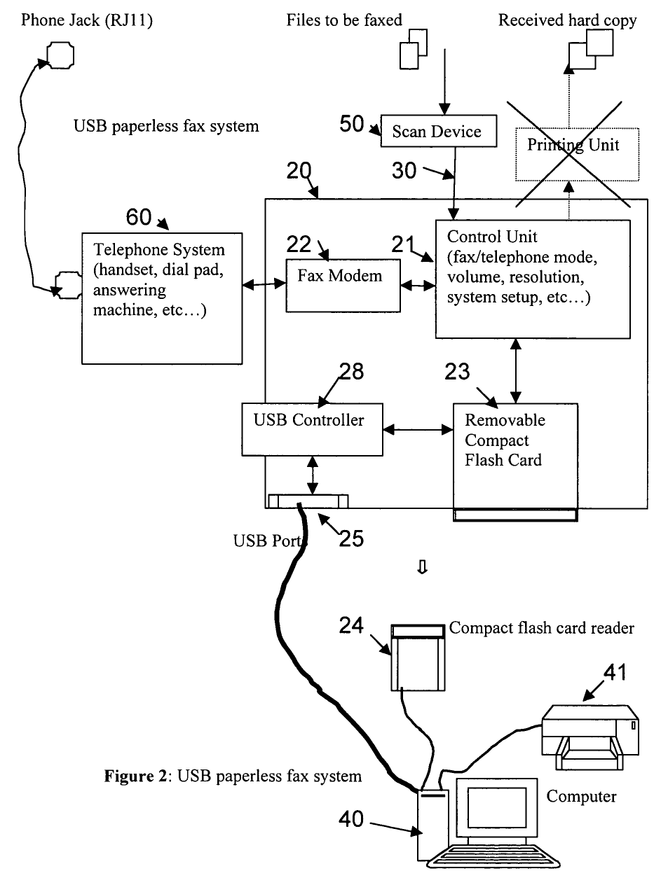

In FIG. 2, a paperless fax system 20 with expanded communication capability, the system 20 comprises a programmable control unit 21 that receives digital information 30 from an external scanning device 50 electronically interconnected with the control unit 21. The control unit 21 has a fax modem 22 that may receive and send digital information 30 over an existing telecommunication system 60. The paperless fax system 20 also comprises a removable compact flash card 23 interconnected to the control unit 21. The compact flash card 23 may be used with a compact flash card reader 24 to transmit digital information 30 to an existing computer 40. The paperless fax system 20 further comprises a USB port 25 attached to the control unit 28. The USB port 25 may communicate with an external computer 40 and printer 41 and with the World Wide Web to transmit facsimile files 30 from the scanner 50.

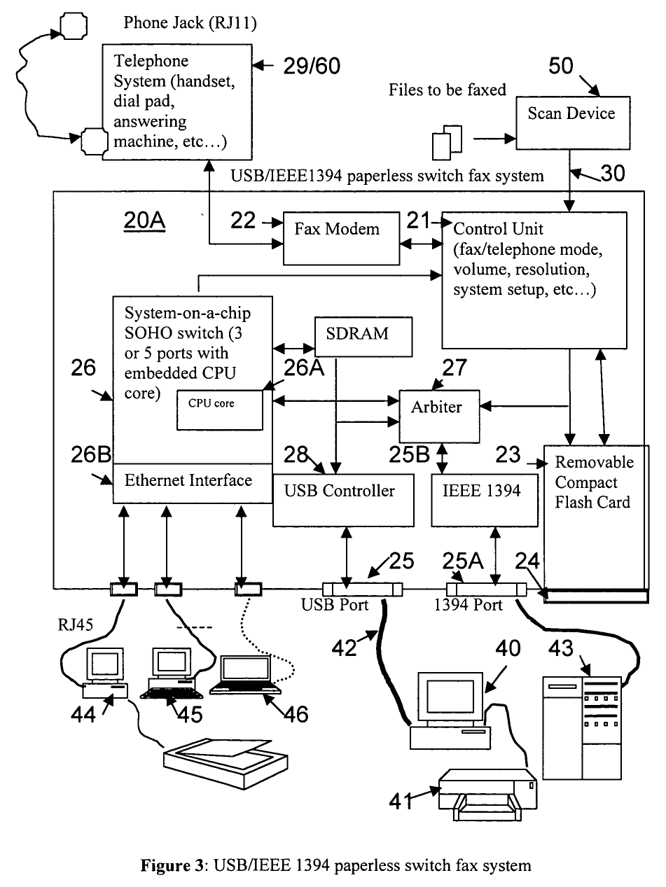

In FIG. 3, a paperless fax system 20A comprises a preferably 3 or 5 port multi-port switch system-on-a-chip 26 with an embedded CPU 26A and a data flow arbiter 27 connected to the control unit 28, wherein the system-on-a-chip 26 has an Ethernet interface 26B to communicate with external networking devices 44-46 attached to it. The system-on-a-chip 26 also has a CPU core 26A to read and write data 30 in the compact flash card 23 and schedule facsimile tasks with the control unit 21. The arbiter 27 is used to control the data flow between the system-on-a-chip 26, the USB port 25 and other communication ports 25A and 25B. The communication ports 25, 25A and 25B of the system 20A may also include an IEEE 1394 port 25B.

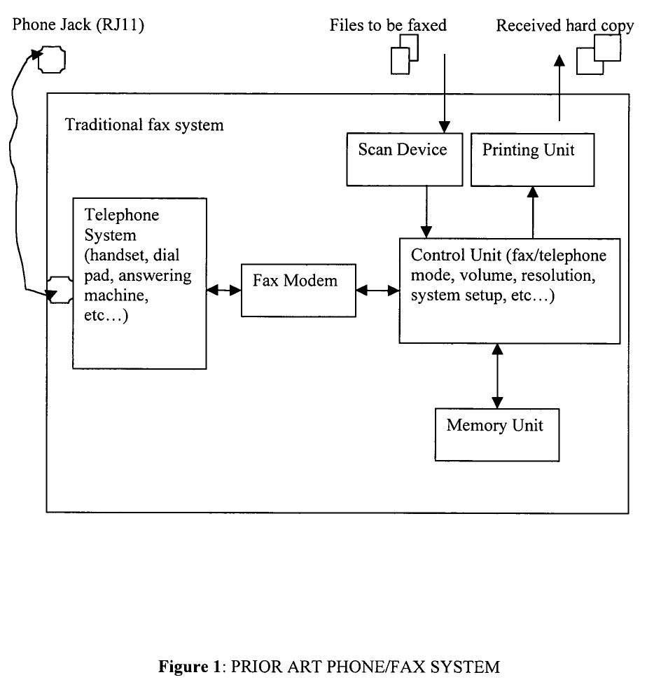

In practice, the paperless facsimile system 20, shown in FIG. 2 would receive facsimile data 30 through a fax modem 22 and control unit 21, then store the data 30 into a compact flash card 23. When a user wants to view or delete the fax 30, he or she can use a compact flash card reader 24 or hook up a USB cable 42 to connect to the USB port of a computer 40. The imagines or pictures 30 may then be viewed from the computer 40 screen. The facsimile data 30 can be printed out later from the printer 41 connected to the computer 40. The fax machine 20 may transmit facsimile documents 30 from a scan device 50 like a traditional fax machine, which prior art is shown in FIG. 1. The fax machine 20 includes a telephone system 29, which may be used as traditional telephone system. The fax machine 20 may also be used as a black/color scanner. The device 20 may store the scanned pictures 30 in the compact memory 23. Users can view and download the data 30 to their computers 40 from the USB port 25.

In practice, the USB Paperless Switch Fax System 20A, shown in FIG. 3, may receive incoming faxes 30. Upon receiving, the data 30 will be stored into the compact flash card 23. Users can view or delete the fax 30 from all the devices 44-46 hooked with the Ethernet switch 26B. The fax 30 can also be read similar to the USB paperless fax system 20 by using a compact flash card reader 24 or from its USB port 25 or switching ports 25A or 25B. The document 30 can be printed out from the printer 41 connected to the computer 40 or network 43-46. The fax machine 20A can also fax documents 30 that generate from scan device 50, or transmit scheduled fax events by networking device 43-46. The fax machine 20A may further be used as a traditional telephone, or a black/color scanner. The device 20A may store scanned pictures 30 in the compact memory 23. Users can view and download the data 30 to their computers 40 from the USB port 25. Many computers 44-46 can connect to its switch ports 25A or 25B through a network 43 to access the files 30 at the same time.

It is understood that the preceding description is given merely by way of illustration and not in limitation of the invention and that various modifications may be made thereto without departing from the spirit of the invention as claimed.

1. A paperless fax system with expanded communication capability, the system comprising:
a programmable control unit capable of receiving digital information from an external scanning device electronically interconnected with the control unit, the control unit having a fax modem capable of receiving and sending digital information over an existing telecommunication system;
a removable compact flash card interconnected to the control unit, the compact flash card capable of being used with a compact flash card reader to transmit digital information to an existing computer; and
a USB port attached to the control unit, the USB port capable of communicating with an external computer and printer and with the world wide web to transmit facsimile files from the scanner.

2. The system of claim 1 further comprising a multi-port switch system-on-a-chip with an embedded CPU and a data flow arbiter connected to the control unit, wherein the system-on-a-chip has an Ethernet interface to communicate with external networking devices attached to it and also has a CPU core to read and write data in the compact flash card and schedule facsimile tasks with the control unit and the arbiter is used to control the data flow between the system-on-a-chip, the USB port and other communication ports.

3. The system of claim 2 wherein at least one of the other communication ports comprises an IEEE 1394 port.

4. The system of claim 1 wherein the multi-port switch comprises three ports.

5. The system of claim 1 wherein the multi-port switch comprises five ports.
